(19) United States
(12) Patent Application Publication
(10) Pub. No.: US 2022/0111432 A1
(43) Pub. Date: Apr. 14, 2022

(54) MOLD COOLING STRUCTURE

(71) Applicant: TOYOTA JIDOSHA KABUSHIKI KAISHA, Toyota-shi (JP)

(72) Inventor: Hironori TAKASAKA, Hamamatsu-shi (JP)

(73) Assignee: TOYOTA JIDOSHA KABUSHIKI KAISHA, Toyota-shi (JP)

(21) Appl. No.: 17/484,073

(22) Filed: Sep. 24, 2021

(30) Foreign Application Priority Data
Oct. 9, 2020 (JP) 2020-170940

(51) Int. Cl. B21D 37/16; B29C 33/04

(52) U.S. Cl. CPC B21D 37/16; B29C 33/04

(57) ABSTRACT

A mold cooling structure according to the present disclosure includes a first refrigerant flow channel through which a first refrigerant for cooling a mold flows; and a second refrigerant flow channel through which a second refrigerant for cooling the first refrigerant flowing through the first refrigerant flow channel flows. Further, the second refrigerant flow channel extends along the first refrigerant flow channel. Furthermore, mutual heat exchange between the first refrigerant and the second refrigerant is performable.

### CROSS REFERENCE TO RELATED APPLICATIONS

This application is based upon and claims the benefit of priority from Japanese patent application No. 2020-170940, filed on Oct. 9, 2020, the disclosure of which is incorporated herein in its entirety by reference.

### BACKGROUND

The present disclosure relates to a mold cooling structure.

When a mold is used to mold an object to be molded, the mold becomes hot. Therefore, the mold is provided with a cooling structure that can cool the mold by causing a refrigerant such as cooling water, cooling oil, or the like to flow through the mold. For instance, Japanese Unexamined Patent Application Publication No. 2016-172401 discloses a technique of cooling a molded product and a mold by causing cooling water to flow into the mold.

### SUMMARY

As described above, the mold can be cooled by flowing a refrigerant such as cooling water, cooling oil, or the like through a flow channel provided in the mold. However, with the technique disclosed in Japanese Unexamined Patent Application Publication No. 2016-172401, when a refrigerant flows through the flow channel in one direction, the temperature of the refrigerant rises as the refrigerant flows through the flow channel. This causes a problem that the part of the mold (that is, the cooling target), which is distant from the inflow port of the refrigerant, is not sufficiently cooled.

An object of the present disclosure is to provide a mold cooling structure that can exhibit a cooling performance even for the part of the mold that is distant from the inflow port of the refrigerant.

A mold cooling structure according to the present disclosure includes:

a first refrigerant flow channel through which a first refrigerant for cooling a mold flows; and

a second refrigerant flow channel through which a second refrigerant for cooling the first refrigerant flowing through the first refrigerant flow channel flows, in which

the second refrigerant flow channel extends along the first refrigerant flow channel, and

mutual heat exchange between the first refrigerant and the second refrigerant is performable.

According to the present disclosure, a mold cooling structure that can exhibit a cooling performance even for the part of the mold that is distant from the inflow port of the refrigerant.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram of a mold cooling structure according to a first embodiment;

FIG. 2A is a cross-sectional diagram of a refrigerant flow channel according to a first embodiment of the present disclosure;

FIG. 2B is a cross-sectional diagram of the refrigerant flow channel according of the first embodiment of the present disclosure; and

FIG. 3 is a schematic diagram of a mold cooling structure according to a prior art.

### DESCRIPTION OF EMBODIMENTS

Hereinbelow, the embodiments of the present disclosure will be described with reference to the drawings. Note that since the drawings are simplified, the technical scope of the embodiments should not be construed narrowly on the basis of these drawings. In the drawings, the identical reference symbols denote identical structural elements and the redundant explanation thereof is omitted. Further, in the following embodiments, when referring to the number of elements or the like (including the number, the numerical value, the quantity, the range, and the like), the number is not limited to that specified, that is, the number is neither greater or smaller than the specified number except in the case of where the number is limited to a specific number.

Hereinbelow, for the sake of clarifying the explanation, the XYZ 3D-orthogonal coordinate system is used. Y-direction is the thickness direction of a mold. XZ-plane is a plane that is parallel to the main surface of the mold. Hereinbelow, the explanation will be given on the assumption that the positive Y-direction is the top-side direction, however, it may vary depending on the orientation of the mold.

<Details of Study on Conceiving the Mold Cooling Structure According to the Embodiments>

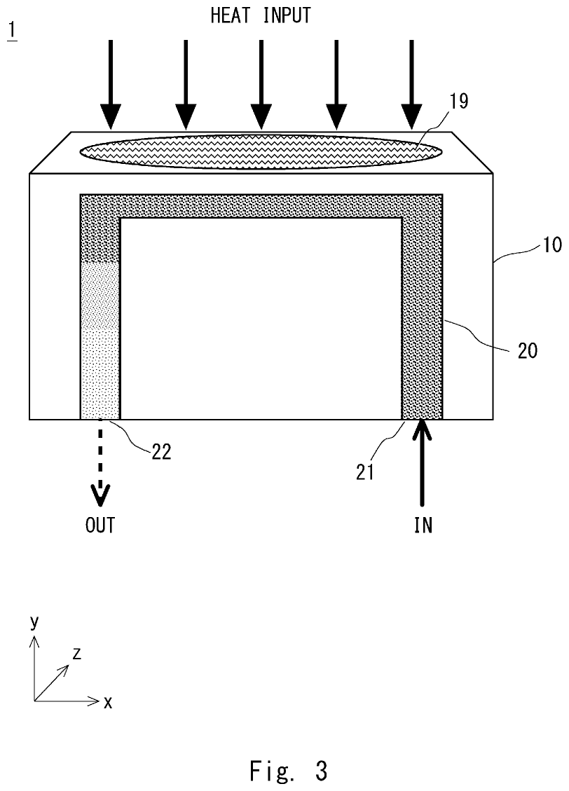

As a premise for describing the structure according to the present disclosure, the problems of the related art will be described with reference to FIG. 3. FIG. 3 is a schematic diagram of a core 10 of a mold 1 including a refrigerant flow channel. An unillustrated cavity is formed on the top side (positive Y-side) of the core 10. By injecting a material such as resin that forms the base of the mold into a hollow space configured of the core 10 and the cavity, the molded product is formed. At this time, as shown in FIG. 3, the core 10 is heated from the top side (the positive Y-direction) thereof by the melted resin or the like to thereby form a heating surface 19.

A refrigerant flow channel 20 is disposed inside the core 10. Although the refrigerant flow channel 20 is not usually visible from the outside, it is illustrated intentionally in FIG. 3 for the sake of describing the state of the refrigerant flow channel 20.

The core 10 of the mold 1 causes the refrigerant to flow into the mold 1 in order to cool the heating surface 19, whereby the molded product and the mold 1 are cooled. As shown in FIG. 3, the refrigerant flow channel 20 is disposed inside the core 10 of the mold 1, and the refrigerant flows therethrough. In FIG. 3, the refrigerant flows into the refrigerant flow channel 20 through an inflow port 21 and is discharged from the refrigerant flow channel 20 through a discharge port 22.

As shown in FIG. 3, when a refrigerant flows through the refrigerant flow channel 20, the temperature of the refrigerant rises as the refrigerant flows through the refrigerant flow channel from the inflow port 21 to the discharge port 22. Therefore, the cooling effect cannot be achieved for the part of the refrigerant flow channel 20 that is close to the discharge port 22. That is, it is difficult to achieve the effect of cooling by the refrigerant for the part of the core 10 of the mold 1 on the negative X-side of the heating surface 19. Further, due to the temperature of the refrigerant flow channel 20 rising, for instance, film boiling occurs inside the refrigerant flow channel 20, causing damage to the refrigerant flow channel 20 itself.

Thus, the mold cooling structure according to the embodiments described below that can solve the aforementioned problem was conceived.

### First Embodiment

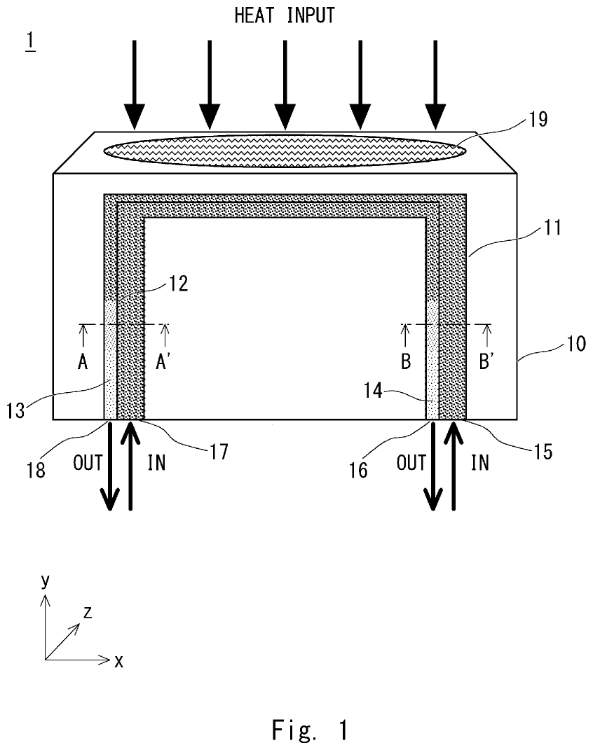

A mold cooling structure according to a first embodiment will be described with reference to FIG. 1. FIG. 1 is a schematic diagram of the core 10 of the mold 1 provided with a penetrating hole 11 through which the refrigerant flows. The penetrating hole 11 is disposed inside the core 10. Although the penetrating hole 11 is not usually visible from the outside, it is illustrated intentionally in FIG. 1 for the sake of describing the state of the penetrating hole 11.

As the refrigerant that flows through the penetrating hole 11 disposed inside the core 10 of the mold 1, a heat medium such as cooling oil, cooling water, or the like is employed.

In the first embodiment, the penetrating hole 11 is described as circular in cross-section, but it is not limited thereto and may be, for instance, rectangular. The shape of the penetrating hole 11 in cross-section may be any shape as long as the refrigerant can flow through the penetrating hole 11. In the first embodiment, two refrigerant flow channels 13 and 14 are formed by providing a partition 12 in the penetrating hole 11. The partition 12 can be collectively referred to as, for instance, a reinforcing part, a support part, a protruding part, a wall, and a plate. Further, the partition 12 is formed of, for instance, the material same as that of the rest of the core and is laminated on the penetrating hole 11, but it is not limited thereto and the partition 12 may be fixed to the wall of the penetrating hole 11.

As shown in FIG. 1, the first refrigerant flow channel 13 and the second refrigerant flow channel 14 are formed by providing the partition 12 in the penetrating hole 11. The first refrigerant flow channel 13 and the second refrigerant flow channel 14 can perform heat exchange with each other. Note that in the first embodiment, the first refrigerant flow channel 13 and the second refrigerant flow channel 14 are separated by the partition 12, however it is not limited thereto and the first refrigerant flow channel 13 and the second refrigerant flow channel 14 may be configured as independent channels as long as they can be perform heat exchange.

As shown in FIG. 1, the second refrigerant flow channel 14 extends along the first refrigerant flow channel 13 with the partition 12 disposed between the first refrigerant flow channel 13 and the second refrigerant flow channel 14. Further, the first refrigerant flow channel 13 is partitioned so that it is disposed on the side closer to the heating surface 19 of the core 10 than to the second refrigerant flow channel 14. That is, the refrigerant that flows through the first refrigerant flow channel 13 (a first refrigerant) has a role of cooling the mold 1 and the molded product.

Further, as shown in FIG. 1, the second refrigerant flow channel 14 is partitioned so that it is disposed further distant from the heating surface 19 of the core 10 than the first refrigerant flow channel 13 is. That is, the refrigerant that flows through the second refrigerant flow channel 14 (a second refrigerant) has a role of cooling the mold 1 and the molded product.

In the first embodiment, the refrigerant that flows through the first refrigerant flow channel 13 and the refrigerant that flows through the second refrigerant flow channel 14 flow in directions opposite to each other as shown by the arrows in FIG. 1. That is, the first inflow port 15 into which the refrigerant that flows through the first refrigerant flow channel 13 flows and the second discharge port 16 out from which the refrigerant that flows through the second refrigerant flow channel 14 is discharged are provided adjacent to each other with the partition 12 disposed between the first inflow port 15 and the second discharge port 16. Further, the second inflow port 17 into which the refrigerant that flows through the second refrigerant flow channel 14 flows and the first discharge port 18 out from which the refrigerant that flows through the first refrigerant flow channel 13 is discharged are provided adjacent to each other with the partition 12 disposed between the second inflow port 17 and the first discharge port 18.

The partition 12 disposed between the first refrigerant flow channel 13 and the second refrigerant flow channel 14 is configured so that mutual heat exchange can be performed between the refrigerant that flows through the first refrigerant flow channel 13 and the refrigerant that flows through the second refrigerant flow channel 14. By performing heat exchange between the respective refrigerants flowing in the directions opposite to each other, it is possible to suppress rise in the temperature of the refrigerant present in the first refrigerant flow channel 13 even at a position of the first refrigerant flow channel 13 that is distant from the first inlet port 15. This is because the refrigerant that flows through the second refrigerant flow channel 14 is prone to absorb heat from the refrigerant that flows through the first refrigerant flow channel 13. That is, it is easy to achieve the effect of cooling by the refrigerant for the part of the core 10 of the mold 1 on the negative X-side.

Further, by adjusting the thickness of the partition 12, the degree of the heat exchange performed between the refrigerant that flows through the first refrigerant flow channel 13 and the refrigerant that flows through the second refrigerant flow channel 14 can be adjusted whereby the cooling efficiency of the first refrigerant flow channel 13 with respect to the mold 1 and the mold product can be adjusted.

Further, as shown in FIG. 1, by adjusting the position of the partition 12 disposed between the first refrigerant flow channel 13 and the second refrigerant flow channel 14, it is possible to suppress rise in the temperature of the refrigerant present in the first refrigerant flow channel 13 even more at a position of the first refrigerant flow channel 13 that is distant from the first inlet port 15.

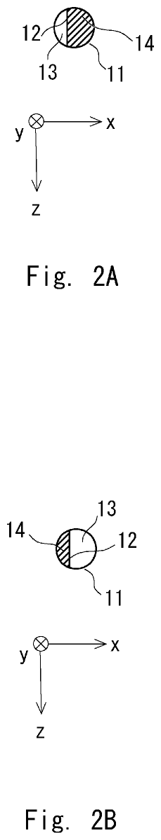

FIG. 2A is a cross-section of FIG. 1 cut along the line A-A′ and FIG. 2B is a cross-section of FIG. 1 cut along the line B-B′. In FIG. 2A, the refrigerant that flows through the first refrigerant flow channel 13 flows in the negative Y-direction and the refrigerant that flows through the second refrigerant flow channel 14 flows in the positive Y-direction. Further, in FIG. 2B, the refrigerant that flows through the first refrigerant flow channel 13 flows in the positive Y-direction and the refrigerant that flows through the second refrigerant flow channel 14 flows in the negative Y-direction.

For example, as shown in FIGS. 1, 2A, and 2B, a cross-sectional area of the first inflow port 15 into which the refrigerant that flows through the first refrigerant flow channel 13 flows is made larger than a cross-sectional area of the second discharge port 16 out from which the refrigerant that flows through the second refrigerant flow channel 14 is discharged, and the cross-sectional area of the second discharge port 16 out from which the refrigerant that flows through the second refrigerant flow channel 14 is discharged is made smaller than the cross-sectional area of the first inflow port 15 into which the refrigerant that flows through the first refrigerant flow channel 13 flows. Further, a cross-sectional area of the second inflow port 17 into which the refrigerant that flows through the second refrigerant flow channel 14 flows is made larger than a cross-sectional area of the first discharge port 18 out from which the refrigerant that flows through the first refrigerant flow channel 13 is discharged, and the cross-sectional area of the first discharge port 18 out from which the refrigerant that flows through the first refrigerant flow channel 13 is discharged is made smaller than the cross-sectional area of the second inflow port 17 into which the refrigerant that flows through the second refrigerant flow channel 14 flows. The smaller the respective cross-sectional areas of the refrigerant flow channels 13 and 14, the faster the flow rate of the refrigerant that flows through each of the refrigerant flow channels 13 and 14 becomes.

As described above, by disposing the partition 12 so as to vary the cross-sectional areas of the refrigerant flow channels, the flow rate of the refrigerant that flows through each of the refrigerant flow channels 13 and 14 can be increased for the respective parts of the refrigerant flow channels 13 and 14 where the temperature of the refrigerant has increased whereby it is possible to further suppress rise in the temperature of the refrigerant. Further, the flow rate of the refrigerant is small in the respective parts of the refrigerant flow channels 13 and 14 where the temperature of the refrigerant flowing therethrough has not increased.

According to the first embodiment, it is possible to provide a mold cooling structure that can exhibit a cooling performance even for the part of the mold that is distant from the inflow port of the refrigerant.

### OTHER EMBODIMENTS

In the first embodiment, one pair of the first refrigerant flow channel 13 and the second refrigerant flow channel 14 are disposed inside the core 10 of the mold 1, however two or more pairs of the same may be disposed. Further, the first refrigerant flow channel 13 and the second refrigerant flow channel 14 may be disposed inside the cavity (not shown) of the mold 1.

The present disclosure has been described according to the aforementioned embodiment. However, the present disclosure is not limited to the configuration described in the aforementioned embodiments and can be naturally changed, modified, or combined variously within the scope of the claims of the present application by one skilled in art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A mold cooling structure comprising:
a first refrigerant flow channel through which a first refrigerant for cooling a mold flows; and
a second refrigerant flow channel through which a second refrigerant for cooling the first refrigerant flowing through the first refrigerant flow channel flows, wherein
the second refrigerant flow channel extends along the first refrigerant flow channel, and
mutual heat exchange between the first refrigerant and the second refrigerant is performable.

2. The mold cooling structure according to claim 1, wherein the first refrigerant and the second refrigerant flow in directions opposite to each other.

3. The mold cooling structure according to claim 1, wherein
a cross-sectional area of an inflow port of the first refrigerant flow channel into which the first refrigerant flows is larger than a cross-sectional area of a discharge port of the second refrigerant flow channel from which the second refrigerant is discharged, and
a cross-sectional area of an inflow port of the second refrigerant flow channel into which the second refrigerant flows is larger than a cross-sectional area of a discharge port of the first refrigerant flow channel from which the first refrigerant is discharged.

4. The mold cooling structure according to claim 1, wherein the first refrigerant flow channel and the second refrigerant flow channel are formed by disposing a partition in one penetrating hole.
